(19) United States
(12) Patent Application Publication
(10) Pub. No.: US 2009/0165238 A1
(43) Pub. Date: Jul. 2, 2009

(54) WEB SUBSTRATE CLEANING SYSTEMS & METHODS

(76) Inventor: LESLIE BENNETT, Bingley (GB)

Correspondence Address: TROUTMAN SANDERS LLP;BANK OF AMERICA PLAZA, 600 PEACHTREE STREET, N.E., SUITE 5200, ATLANTA, GA, 30308-2216, US

(21) Appl. No.: 12/325,124

(22) Filed: Nov. 28, 2008

Related U.S. Application Data
(63) Continuation of application No. 10/682,209, filed on Oct. 8, 2003, now abandoned.

(51) Int. Cl. B08B 5/02

(52) U.S. Cl. 15/309.1; 15/306.1

(57) ABSTRACT

Web substrate cleaning systems and methods are provided. In some embodiments, a web cleaning system for removing debris from a substrate surface can generally comprise idlers and rollers. A web of substrate material can be held between the idlers, and moved at a first velocity to create a web boundary layer to hold debris on the web. A pair of counter rotating smooth, uniform surfaced rollers can rotate in an opposite direction to that of the web. The smooth, uniform surfaced rollers can have a substantially uniform surface with no extensions extending from the surface of the rollers. The rotating smooth, uniformed surfaced rollers can define a rotating boundary layer encasing the rollers that impinge the web boundary layer. Such impingement can cause the web boundary layer to releases debris from the web to the rotating boundary layer. Other aspects, embodiments, and features are also claimed and described.

### CROSS REFERENCE TO RELATED APPLICATION & PRIORITY CLAIM

This application is a continuation of U.S. Nonprovisional application Ser. No. 10/682,209, filed 8 Oct. 2003, which is hereby incorporated by reference as is fully set forth below.

### TECHNICAL FIELD

Embodiments of the present invention relate generally to web cleaners in general and more specifically, to a treatment system that lifts debris from the surface of a web of substrate material without touching either of its upper and lower surfaces.

### BACKGROUND

Web cleaners have been conventionally used to provide a means for removing unwanted particles from the surface of a web in the printing discipline. Several conventional approaches exist, and while serving their respective purposes, these approaches have drawbacks. Bristles, in the form of a brush rotating at various speed have been employed that lightly brush exterior surfaces of a web. Compressed air has been tried that was somewhat successful, however it was found that it required almost two pounds per square inch, which required considerable energy and had other complications. The combination of a rotating brush and vacuum was considered to be a viable solution, however, it requires vacuum blowers at high volume and brushes that contacted the surface of the web.

What is needed, therefore, are improved web substrate cleaning systems and methods. It is to such web substrate cleaning systems and methods that the various embodiments of the present invention are directed.

### BRIEF SUMMARY OF EXEMPLARY EMBODIMENTS

In the printing discipline which includes lithographic offset printing, flexographic printing, gravure printing, letterpress printing and the like, in the lithographic process blanket piling is a source of wasted time and lost production due to the necessity of frequent blanket washes. Lint, paper fibers and coating on the surface of the substrate can cause halftone plugging and so called “hickeys”, which requires removal and washing of the blanket. Frequent blanket washes shorten a blanket's life and place unnecessary wear and premature deterioration of a printing press. It is, therefore, an object of embodiments of the present invention to clean the surface of a web.

An object of embodiments of the invention is directed to condition high speed webs by penetrating a surface barrier air boundary layer of a web without actual contact. Embodiments of the present invention enable production of an air flow that provides air currents to clean a web surface. Embodiments of the present invention can be configured to be operate with almost any substrate used in printing, without damaging the surface, including paper, mylar, and plastic.

Another object of some embodiments of the present invention is to apply air currents that are produced by one or more rollers. The rollers can have a smooth, uniform surface. Rollers with a uniform exterior surface can create a fluid air boundary area immediately at an extreme close space existing between the roller and the web. This enables an air boundary layer close to the web to dislodge debris and moves loose particles without actually touching the web. Particles lifted from the web surface can be directed to a separate device that receives and stores the debris. In some embodiments, rollers have been found to work best when the roller's surface speed is at least 20 percent greater than the surface speed of the web.

In some embodiments of the present invention, rollers rotate in the opposite direction to the moving web. This feature provides air currents that surround the rotating roller to be easily directed into a plenum. A plenum can include a air separating bar that separates air containing particles that have been removed from the web from the roller and directs the airflow into a dust collector.

Yet another object of embodiments of the invention is to condition a web surface for improved printability characteristics. Conditioned webs can reduce contamination in not only the ink train and dampers but also specifically the blankets and the printing plates of the printing equipment.

Generally described, some embodiments provide a web cleaning system for removing debris from a substrate surface. Such a web system can comprise idlers and rollers. The idlers can hold a web of substrate material. The web can be moved at a first velocity which acts to create a web boundary layer which acts to hold debris on the web. The idlers can be a pair of counter rotating smooth, uniform surfaced rollers rotating in an opposite direction to that of the web. The rollers can have a substantially uniform surface with no extensions extending from the surface of the rollers. The rollers can define a rotating boundary layer encasing the rollers that impinge the web boundary layer such that the web boundary layer releases debris from the web to the rotating boundary layer. Some embodiments can have a plenum enclosing each roller to collect debris held within the rotating boundary layer. Also, the substrate material can be paper, mylar, and/or thermoplastic film. Also, the pair of counter rotating smooth, uniform surfaced rollers can have a rotational velocity higher than the first velocity of the web.

Briefly described, some embodiments can provide a web cleaning system, comprising a plurality of idlers holding a web of driven substrate material. The pair of counter rotating smooth surface rollers can be spaced apart from the web, rotate in an opposite direction to that of the web, and configured not to physically touch the web. Also, the system can comprise a plenum. The plenum can enclose a roller and a separating bar to collect debris from the web surface by air currents that are formed by rotation of the rollers. The rollers can create an air film on the web surface and also the rotation of the rollers creates positive air pressure within each plenum. In some embodiments, a pair of counting rotating smooth surface rollers can be spaced apart from the web at generally the same distance.

Still yet other embodiments can comprise a web cleaning system for removing debris from a substrate surface. For example, a web system can comprise idlers and rollers. A plurality of idlers and a web of substrate material can be disposed between the idlers. The web can be moved at a first velocity which acts to create a web boundary layer which acts to hold debris on the web. A first smooth, uniform surfaced roller can rotate in a direction opposite of the web at a second velocity, the first smooth, uniform surfaced roller having a substantially uniform surface with no extensions extending from the surface of the first smooth, uniform surfaced roller. A second smooth, uniform surfaced roller can rotate in a direction opposite of the web at a third velocity, the second smooth, uniform surfaced roller having a substantially uniform surface with no extensions extending from the surface of the second smooth, uniform surfaced roller. The boundary layers can move along approximately the same approximate plane and in opposite directions at a nip position where the rollers are closest to each other to avoid compressing the web boundary layer defined on each side of the web. The first and second rotating smooth, uniform surfaced rollers can define a rotating boundary layer that encases rollers that impinge the web boundary layer such that the web boundary layer is disturbed to release debris from the web to the rotating boundary layer.

Web cleaning systems according to embodiments of the present invention can also have additional features. For example, the second and third velocities are substantially equal. Also, the first velocity is less than second and third velocities such that the magnitude of the rotating boundary layer is greater than that of the web boundary layer. In addition, the second and third velocity is at least 10 percent greater than the first velocity. Still yet, the second and third velocities are approximately fifty percent to achieve a high cleaning efficiency. And in some embodiments, a system can comprise an air flow positioned tangentially to each of the first and second smooth, uniform surfaced rollers, and the air flow can have a velocity greater than fifty percent of the first velocity. A web cleaning system can also have covers covering each of the first and second smooth, uniform surfaced rollers. The covers can be concentric to the roller surfaces and substantially clear such that the web boundary layer does not interfere with the rotating boundary layer. In some embodiments, a system can comprise a gap positioned between the web and the two rollers having a distance between about 1 mm to 3 mm. Still yet in some embodiments, a web cleaning system can comprise a gap spaced between the web and the two rollers. The gap can be configured to reduce the volume of air flowing in the nip position and increase time it takes for the web boundary layer to reform, increase velocity of air flowing into the gap thereby reducing thickness of web substrate boundary layer leaving the nip position.

Other aspects and features of embodiments of the present invention will become apparent to those of ordinary skill in the art, upon reviewing the following description of exemplary embodiments of the present invention. While features of the present invention may be discussed relative to certain embodiments and figures, all embodiments of the present invention can include one or more of the advantageous features discussed herein. Indeed, while one or more embodiments may be discussed as having certain advantageous features, one or more of such features may also be used with various embodiments of the invention discussed herein. Also, while discussion may, at times, focus on printer web substrate cleaners, embodiments of the present invention can also be used for many other types of substrate cleaners. In similar fashion, while exemplary embodiments may be discussed below as being device, system, or method embodiments, it should be understood that such exemplary embodiments can also be configured as devices, systems, and methods even though not expressly discussed as such.

### BRIEF DESCRIPTION OF THE DRAWINGS

The above and other embodiments, objects, features, and advantages of the present invention will be apparent upon consideration of the following detailed discussion, taken in conjunction with the accompanying drawings, in which:

FIG. 1 is a partial isometric view of a web substrate cleaning apparatus in accordance with some embodiments of the present invention.

FIG. 2 is a schematic end view of a web substrate cleaning apparatus in accordance with some embodiments of the present invention with arrows indicating the rotation and flowpath of the web.

FIG. 3 is a partial isometric view of a web substrate cleaning apparatus in accordance with some embodiments of the present invention installed on a lithographic printing press.

FIG. 4 is a partial isometric view of one of a smooth roller used in accordance with some embodiments of the present invention.

FIG. 4A is a partial isometric view of one of the textured rollers having a fabric-tufted buffing material surrounding the outside surface, illustrated by itself removed from the invention for clarity.

FIG. 5 is a partial isometric view of one of the textured rollers having a number of resilient blades on the outer outside surface, shown completely removed from the invention for clarity.

FIG. 6 is a partial isometric view of one of the textured rollers having an irregular surface on the roller, with the roller completely removed from the invention for clarity.

FIG. 7 is a schematic end view of a web substrate cleaning apparatus in accordance with some embodiments of the present invention with the air flow currents shown with directional arrows.

FIG. 8 is a schematic end view of rollers and their proximity relationship with the web in a web substrate cleaning apparatus in accordance with some embodiments of the present invention.

FIG. 9 is a partial schematic end view of a web substrate cleaning apparatus in accordance with some embodiments of the present invention with the web horizontal entering from the top.

FIG. 10 is a partial schematic end view of a web substrate cleaning apparatus in accordance with some embodiments of the present invention with the web horizontal entering from the bottom.

FIG. 11 is a partial schematic end view of a web substrate cleaning apparatus in accordance with some embodiments of the present invention with the web vertical entering from the top.

FIG. 12 is a partial schematic view of one of a plenum used in a web substrate cleaning apparatus in accordance with some embodiments of the present invention.

FIG. 13 is a cross sectional view taken along lines 13-13 of FIG. 12 illustrating a blunt air separating bar.

FIG. 14 is a cross sectional view taken along lines 14-14 of FIG. 12 illustrating a knife edge air separating bar.

FIG. 15 is a cross sectional view taken along lines 15-15 of FIG. 13 illustrating rectangular openings in the plenum.

### DETAILED DESCRIPTION OF PREFERRED & ALTERNATIVE EMBODIMENTS

To facilitate an understanding of aspects, principles, and features of the various embodiments of the present invention, embodiments of the present invention are explained herein with reference to its implementation in illustrative embodiments. It should be understood that the discussion of exemplary embodiments or best modes do not limit the embodiments contained with the appended claims of the application.

Generally described, embodiments of the present invention are presented in terms of a web cleaning system as shown FIGS. 1-15. A web cleaning system generally comprises a web cleaner 20 that is used for removing particles and other debris from the surface of a substrate web 22 used in a printing press 24. It should be noted that while the invention is specifically designed for use in conjunction with a lithographic press used for offset printing, other presses and printing equipment including letterpress, flexographic, gravure, ink jet or laser, or any other apparatus that utilizes a web requiring cleaning, may benefit equally well. Thus, embodiments of the present invention may be utilized to clean many types of webbed material and materials provided in webbed substrates.

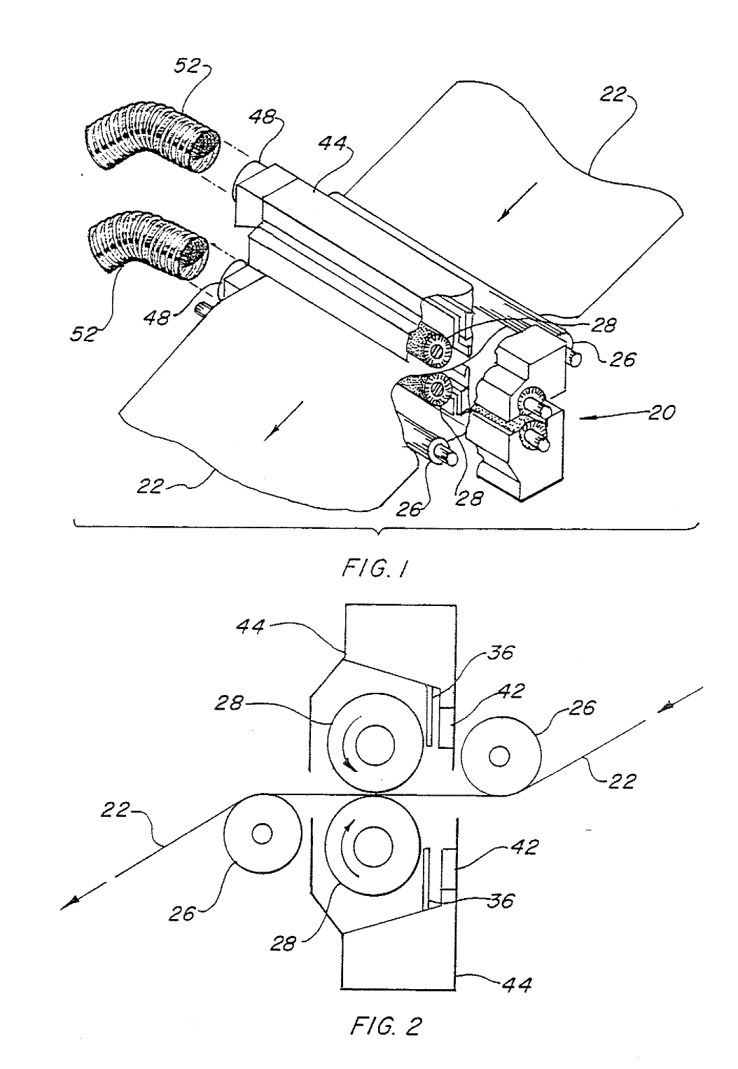

A plurality of path rollers 26, in the form of cylinders, can be utilized in a web cleaning system. The path rollers 26 can be positioned such that a web 22 of substrate material is held taut therebetween, as shown in FIGS. 1 and 2. Location of the rollers 26 and their relative position can be determined by configuring of the printing press and may be varied to accommodate a particular application. The web 22 can be driven at high speeds by the printing press 24. As those of skill in the art will understand, movement of the web 22 with a high velocity can create a boundary layer of air (acting as a fluid) disposed above the web 22. This boundary layer of air can create a force that tends to hold particles on the surface of the web.

FIGS. 9-11 illustrate various web cleaning system embodiments of different configuration. As shown, orientation of the components of the system can depend on where the web 22 enters and departs, such as from the top or bottom or straight through horizontally. The web cleaner 20 may also be angled to correspond with the flowpath of the web 22. Use of the idler roller 26 is in common practice in the industry today and its construction is well known. The web substrate material may be of any type used for printing or other industrial applications where a clean surface is required. The most common material consists of paper, mylar or thermoplastic film.

Rollers used in embodiments of the present invention can be opertatively configured for cleaning the web 22 substrate. For example, a pair of counter rotating rollers 28 (sometimes referred to as roller 28) can be positioned between path rollers 26 as illustrated in FIGS. 1-3 and 7-11. One roller 28 can be unchangeably fixed on each side of the web 22. When the rollers 28 rotate at a velocity, movement of the rollers 28 can establish a boundary layer of air around the circumference of the roller. The fact that the rollers 28 are fixed in their relative position between each other and the web 22 is a distinct advantage and contributes to the novelty of the invention in that it is unnecessary to continually adjust the span of the rollers as is the case with other approaches in the cleaning industry. Exterior surfaces of the rollers 28 do not touch the web surface and there is therefore no wear of the cleaning roller surfaces. The rollers 28 can be positioned at varying distances from the web 22 in accordance with embodiments of the present invention. For example, the positions can range from about 0.001 inches (254 mm) to 0.200 inches (5.08 mm) on each side of the web 22. Other positions can be utilized in other embodiments.

In accordance with the various embodiments, cleaning can occur over a wide range of differential roller/web speeds. In some embodiments, the speed differential between the web 22 and the roller 28 surfaces speed can be at least 9.75 feet per second (3 metres per second); and in other embodiments, the speed differential can be at least 35.75 feet per second (11 metres per second). Generally speaking, the lower the speed differential is, the rollers need to be closer together and the higher the speed differential, the gap between rollers can be increased. As a result, and in accordance with some embodiments, web cleaning system gaps can be designed and configured by first determining approximate roller 28 velocities relative to web 22 speed.

Rollers used in embodiments of the present invention can comprise various features and be configured with various operational characteristics. For example, each roller 28 can rotate in an opposite direction to that of the web's 22 flowpath. In some embodiments, the roller 28 can function best when its surface speed is at least twenty percent greater than the surface speed of the web 22. By operating with a speed differential, turbulence is created when exterior roller 28 surface speed exceeds the paper web 22 speed. As discussed herein, this speed differential speed contributes to actual removal of particle debris from the web 22. At a differential of 9.75 feet per second (3 metres per second) to 35. 75 feet per second (11 metres per second) sufficient turbulence is created in the area surrounding the periphery of the roller 28 to produce air currents that flow radially around from the roller 28.

Roller 28 air currents can be used to clean the surface of the web 22, using natural air movement. Indeed, air currents created by roller 28 movement can interact with the fluid layer of air on the moving web. The roller 28 air currents can have a higher force magnitude than the web 22 boundary layer (due to higher velocity) thereby disrupting the web 22 boundary layer. This disruption leads to the release of debris particles held in place by the web 22 boundary layer. After debris particle disruption, debris particles are released and are then swept into orbit around the exterior surfaces of the rollers 28. Debris particles can then remain in orbit around the rollers 28 until removal. In some embodiments, the pair of counter rotating rollers 28 can each have a speed at least double than the speed of the moving web 22. This can place a high pressure turbulence at an appropriate position simultaneously on both the top and bottom surface of the web 22.

In some embodiments, it is not necessary that the counter rotating rollers are opposite each other. A layout can be made where a back-up roller or a plate or other mechanism which ensures that the web is positioned correctly with respect to the buff or cleaning roller and therefore a system of arrangement can be made to clean just one side of the web. Then optionally at a later position within the machine, the opposite side of the web can be cleaned, or the same side could be cleaned again if required.

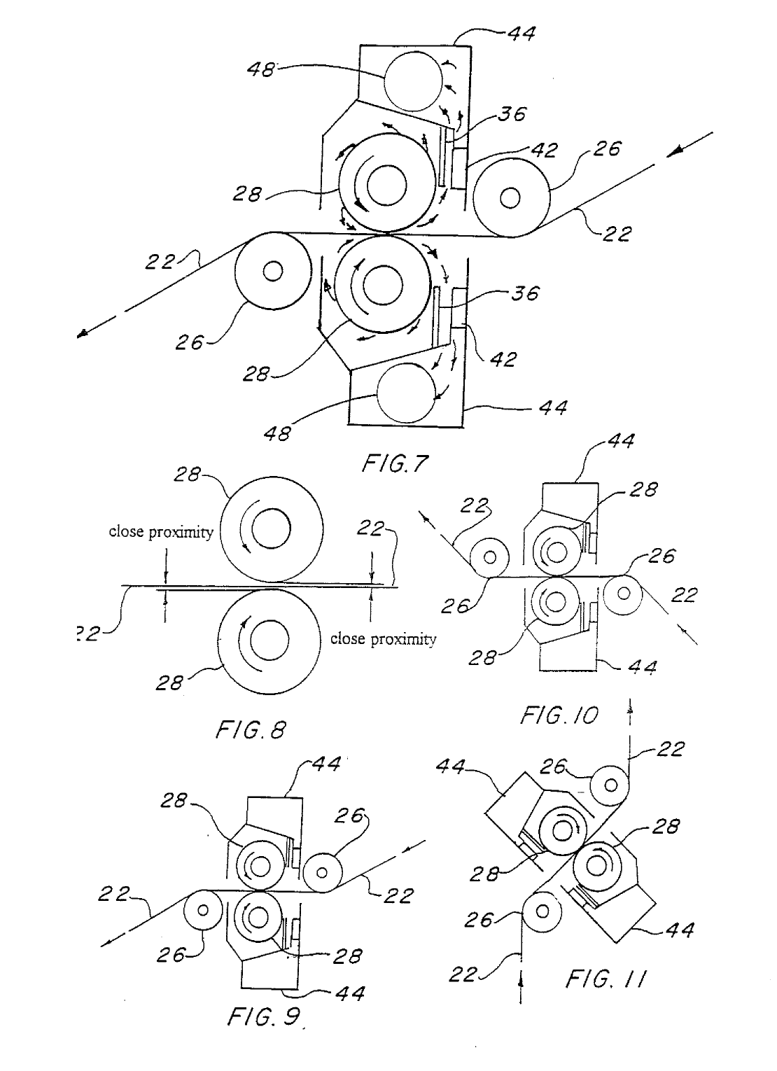

A separating bar 36 is positioned on an upstream side at an angle between 90 degrees to 180 degrees to the web 22 bordering each roller 28 in immediate adjacent relationship therewith as shown in FIGS. 2 and 7. A purpose of each air separating bar 36 is to direct the particle laden air away from the web 22 in the direction of rotation of the roller 28. As illustrated, the air separating bar 36 has a length at least that of the roller 28 and includes a blunt edge 38, shown in FIG. 13 or it can optionally have a sharp pointed edge 40, as illustrated in FIG. 14, or even a rounded edge. A structural support bar 42 is positioned opposite the air separating bar 36 for support of the cleaner 20 and to provide a frame for attachment of the optional path rollers 26, rollers 28 and rotating equipment which is comprised of electric motors and drives, which are not shown, as they are well known in the art and in common usage today.

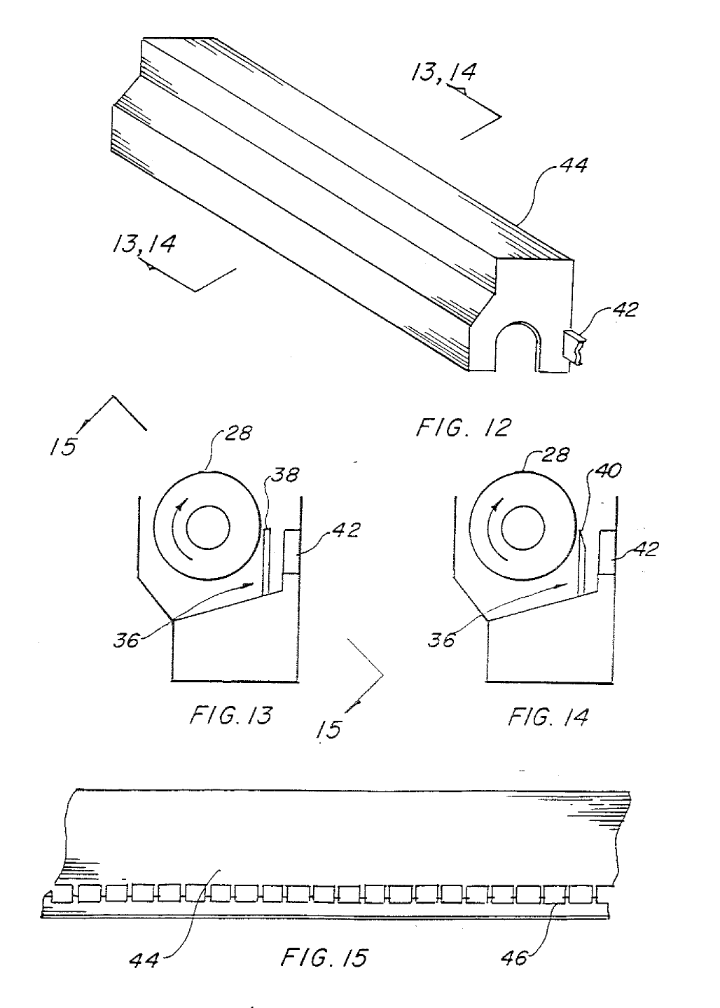

To cover and provide an area for accumulation of debris particles, a plenum 44 can enclose each roller 28 and air separating bar 36 for collecting debris removed from the web surface by air currents formed by rotation of the rollers creating turbulence air on the web 22 surface. The plenum 44 is shown by itself in FIGS. 12-15, and in its relationship with the other elements in FIGS. 1, 2, 7 and 19-11. The plenum 44 is preferably formed from sheet metal stock, blanked and pierced in the flat and broken to the desired shape by sheet metal through a die to obtain a consistent cross-sectional shape. The appropriate roller 28 produces positive turbulent air pressure within the plenum 44 and provides a collecting area for the debris within the air.

Each plenum 44 can contain at least one rectangular opening 46 that are adjacent to a distal end of the separating bar 36, thereby permitting air to flow into the interior of the plenum 44, as shown in FIGS. 13 and 14. The air flow path taken from the periphery of the roller 28 through the plenum 44 is shown in FIG. 7. Each plenum 44 contains an outlet opening 48 on its top, center or end for passing the air from the plenum.

Debris released from the web 22 can be pushed back towards a slot between the support bar 42 and the separating bar 36 which by itself enables most of the debris to be removed, however some small lighter particles may still be in orbit. Therefore a dust collecting or a similar system is in order. When negative pressure is applied by a dust collector or similar system the airflow creates the Bernoulli effect through the slot between the support bar 42 and the air separating bar 36 which by accelerating the airflow generates a low pressure zone which strips the debris, which is still in orbit, and directs it away from the rotating rollers 28.

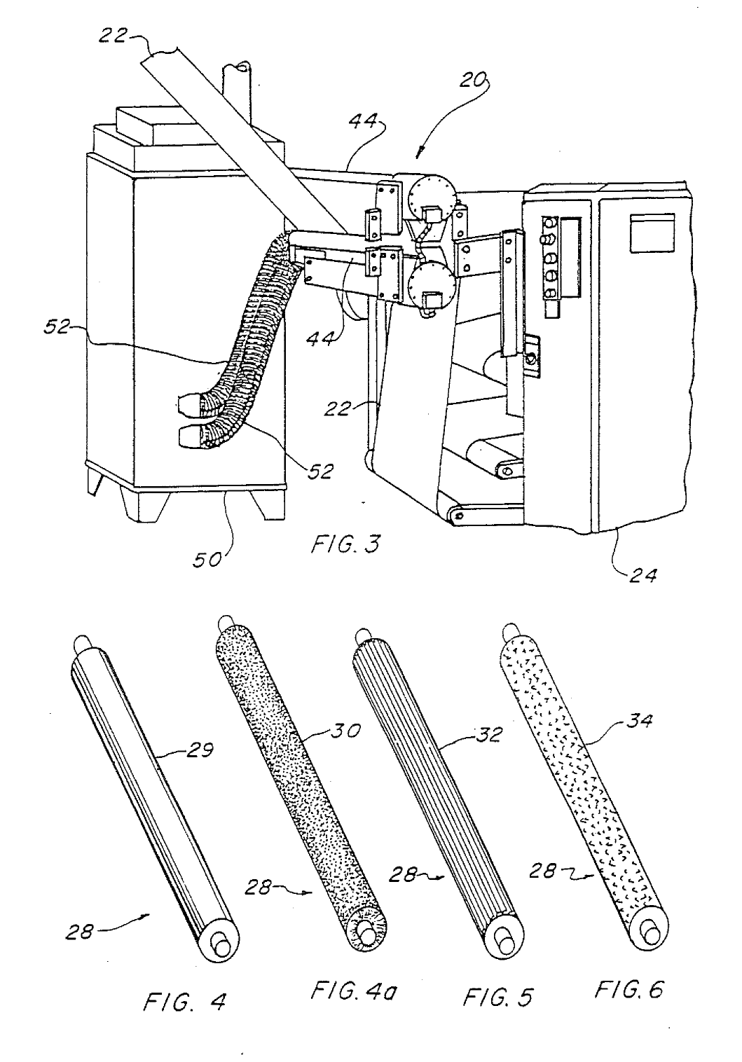

To remove debris and dispose of debris from the surface of the web 22, plenum 44 means for storing debris in the form of a dust collector 50 or similar system is connected to each plenum 44, which ultimately accumulates all of the debris dislodged from the web surface. The connection from the plenum 44 to the dust collector 50 is provided by a flexible hose 52,52 as shown in FIG. 3. Dust collector 50 and hoses 52 are conventional and well known and other similar components may easily replace there utility.

While various embodiments of the dispenser have been disclosed in exemplary forms, those skilled in the art will recognize that many modifications, additions, and deletions can be made without departing from the spirit and scope of the invention and its equivalents. The scope of the various embodiments of the present invention should not be limited to the above discussed embodiments. The following claims further describe illustrative embodiments of the various dispenser embodiments discussed herein. Like the above description, these claims do not limit the scope of the various embodiments of the present invention. Such scope should only be defined by claims to be filed in a later non-provisional application.

I claim:

1. A web cleaning system for removing debris from a substrate surface, the web system comprising:
a plurality of idlers and a web of substrate material held between the idlers, wherein the web is moved at a first velocity which acts to create a web boundary layer which acts to hold debris on the web;
a pair of counter rotating smooth, uniform surfaced rollers rotating in an opposite direction to that of the web, wherein the smooth, uniform surfaced rollers have a substantially uniform surface with no extensions extending from the surface of the rollers;
and wherein the rotating smooth, uniform surfaced rollers define a rotating boundary layer encasing the rollers that impinge the web boundary layer such that the web boundary layer releases debris from the web to the rotating boundary layer.

2. The web cleaning system of claim 1, further comprising a plenum enclosing each roller to collect debris held within the rotating boundary layer.

3. The web cleaning system of claim 1, wherein said substrate material is one of a paper, mylar, and thermoplastic film.

4. The web cleaning system of claim 1, wherein the pair of counter rotating smooth, uniform surfaced rollers have a rotational velocity higher than the first velocity of the web.

5. A web cleaning system, comprising:
a plurality of idlers holding a web of driven substrate material;
a pair of counter rotating smooth surface rollers spaced apart from the web, rotating in an opposite direction to that of the web, and configured not to physically touch the web; and
a plenum enclosing each roller and a separating bar to collect debris from the web surface by air currents that are formed by rotation of the rollers, which creates an air film on the web surface and also the rotation of the rollers creates positive air pressure within each plenum.

6. The web cleaning system of claim 5, wherein the pair of counting rotating smooth surface rollers are spaced apart from the web at generally the same distance.

7. A web cleaning system for removing debris from a substrate surface, the web system comprising:
a plurality of idlers and a web of substrate material disposed between the idlers, wherein the web is moved at a first velocity which acts to create a web boundary layer which acts to hold debris on the web;
a first smooth, uniform surfaced roller rotating in a direction opposite of the web at a second velocity, the first smooth, uniform surfaced roller having a substantially uniform surface with no extensions extending from the surface of the first smooth, uniform surfaced roller;
a second smooth, uniform surfaced roller rotating in a direction opposite of the web at a third velocity, the second smooth, uniform surfaced roller having a substantially uniform surface with no extensions extending from the surface of the second smooth, uniform surfaced roller;
wherein, the two boundary layers are moving along approximately the same approximate plane and in opposite directions at a nip position where the rollers are closest to each other to avoid compressing the web boundary layer defined on each side of the web; and
wherein the first and second rotating smooth, uniform surfaced rollers define a rotating boundary layer encasing the rollers that impinge the web boundary layer such that the web boundary layer is disturbed to release debris from the web to the rotating boundary layer.

8. The web cleaning system of claim 7, wherein the second and third velocities are substantially equal.

9. The web cleaning system of claim 7, wherein the first velocity is less than second and third velocities such that the magnitude of the rotating boundary layer is greater than that of the web boundary layer.

10. The web cleaning system of claim 7, wherein the second and third velocity is at least 10 percent greater than the first velocity.

11. The web cleaning system of claim 7, wherein the second and third velocities are approximately fifty percent to achieve a high cleaning efficiency.

12. The web cleaning system of claim 7, further comprising an air flow positioned tangentially to each of the first and second smooth, uniform surfaced rollers, and the air flow having a velocity greater than fifty percent of the first velocity.

13. The web cleaning system of claim 7, further comprising covers covering each of the first and second smooth, uniform surfaced rollers, the cover being concentric to the roller surfaces and substantially clear such that the web boundary layer does not interfere with the rotating boundary layer.

14. The web cleaning system of claim 7, further comprising a gap positioned between the web and the two rollers having a distance between about 1 mm to 3 mm.

15. The web cleaning system of claim 7, further comprising a gap spaced between the web and the two rollers, the gap configured to reduce the volume of air flowing in the nip position and increase time it takes for the web boundary layer to reform, increase velocity of air flowing into the gap thereby reducing thickness of web substrate boundary layer leaving the nip position.
